(19) United States
(12) Patent Application Publication
(10) Pub. No.: US 2026/0350548 A1
(43) Pub. Date: Nov. 5, 2026

(54) METHODS, SYSTEMS, AND COMPUTER READABLE MEDIA FOR SCHEDULING MEETINGS

(71) Applicant: The Texas A&M University System, College Station, TX (US)

(72) Inventor: Narasimha Reddy Annapareddy, College Station, TX (US)

(73) Assignee: The Texas A&M University System, College Station, TX (US)

(21) Appl. No.: 19/131,022

(22) PCT Filed: Nov. 20, 2023
(86) PCT No.: PCT/US2023/080506

§ 371 Date: May 19, 2025

Related U.S. Application Data
(60) Provisional application No. 63/426,456, filed on Nov. 18, 2022.

(51) Int. Cl. G06Q 10/1093

(52) U.S. Cl. CPC G06Q 10/1093

(57) ABSTRACT

Methods, systems, and computer readable media for scheduling meetings. An example method includes receiving a scheduling request from an organizer for a meeting, the scheduling request identifying a deadline or a window for the meeting, a length of time of the meeting, and participants of the meeting; retrieving scheduling data from each of the participants, the scheduling data comprising availability of the participants; determining a meeting time based on the scheduling data; notifying the participants of the meeting time; and receiving acceptance of the meeting from the participants.

### CROSS-REFERENCE TO RELATED APPLICATIONS

This application claims benefit of U.S. Provisional Application Ser. No. 63/426,456, filed on Nov. 18, 2022, the disclosure of which is incorporated herein by reference in its entirety.

### BACKGROUND

Currently, there is no simple way to schedule a meeting for multiple participants. One current way of accomplishing this goal is to make all the participants' calendars public. However, such an approach results in the loss of privacy over the calendar information of the participants. A second approach is to allow a trusted human access to all the calendars. Then the human can review all the calendars to find a suitable time slot, which is laborious and time-consuming. A third approach is to use mechanisms such as doodle polls that ask the participants to indicate their availability during a number of specified timeslots. This approach leads to several problems including the involvement of multiple participants in providing the information and the provided information becoming stale over the period of scheduling the meeting.

### SUMMARY

Methods, systems, and computer readable media for scheduling meetings. An example method includes receiving a scheduling request from an organizer for a meeting, the scheduling request identifying a deadline or a window for the meeting, a length of time of the meeting, and participants of the meeting; retrieving scheduling data from each of the participants, the scheduling data comprising availability of the participants; determining a meeting time based on the scheduling data; notifying the participants of the meeting time; and receiving acceptance of the meeting from the participants.

The subject matter described herein may be implemented in software in combination with hardware and/or firmware. For example, the subject matter described herein may be implemented in software executed by a processor. In one example implementation, the subject matter described herein may be implemented using a non-transitory computer readable medium having stored therein computer executable instructions that when executed by the processor of a computer control the computer to perform steps. Example computer readable media suitable for implementing the subject matter described herein include non-transitory devices, such as disk memory devices, chip memory devices, programmable logic devices, field-programmable gate arrays, and application specific integrated circuits. In addition, a computer readable medium that implements the subject matter described herein may be located on a single device or computer platform or may be distributed across multiple devices or computer platforms.

### BRIEF DESCRIPTION OF THE DRAWINGS

The subject matter described herein will now be explained with reference to the accompanying drawings of which:

FIG. 1 is a block diagram of an example network environment for a scheduling system.

FIG. 2 is a flow diagram of an example method for scheduling a meeting.

FIGS. 3A-3C are screen shots from an example GUI for a scheduler in a web-based interface.

### DETAILED DESCRIPTION

This document describes a calendar scheduling system that preserves privacy and determines the importance of various meetings already scheduled involving one or more participants identified in a new meeting to be scheduled. Currently, there is no simple way to schedule a meeting for multiple participants. One current way of accomplishing this goal is to make all the participants' calendars public. However, such an approach results in the loss of privacy over the calendar information of the participants. A second approach is to allow a trusted human access to all the calendars. Then the human can review all the calendars to find a suitable time slot, which is laborious and time-consuming. A third approach is to use mechanisms such as doodle polls that ask the participants to indicate their availability during a number of specified timeslots. This approach leads to several problems including the involvement of multiple participants in providing the information and the provided information becoming stale over the period of scheduling the meeting.

What is needed is an efficient technique/method for finding a timeslot for a meeting for a number of participants that preserved privacy and understands the relative importance of already scheduled meetings to find suitable low-cost timeslots when everyone may not be available for a meeting within the provided deadline. Ideally such a method improves over time to reduce the burden on humans for making suitable adjustments to calendars to make the requesting meetings possible.

The algorithm disclosed herein finds an optimal meeting time for participants when possible within the provided deadline and, otherwise, provides minimum cost alternatives when a no-conflict option does not exist. The algorithm may improve over time through machine learning. The scheduling system allows intelligent scheduling of meetings while preserving participants' privacy. The system also determines relative importance of already scheduled meetings, assists users in finding suitable times for meetings, and learns over time to provide improved assistance by implementing machine learning techniques.

The proposed system employs a trusted piece of neutral software that only extracts limited and necessary information for scheduling the requested meeting and immediately discards the collected calendar information after finding a suitable timeslot for the meeting. This software agent/assistant preserves the privacy as no human can view other people's calendars for scheduling purposes. When a no-conflict timeslot is not available, this software assistant provides a number of alternative timeslots that provide a “minimum cost” for organizing the meeting. The “minimum cost” can be defined in a number of ways, including the number of other meetings that have to be rescheduled to make the requested meeting possible, the number of people that would have to be inconvenienced or notified for rescheduling, the number of people who would miss the requested meeting etc. In addition, the software assistant will learn from the human to continuously improve its mechanisms/algorithms to find better solutions over time. The assistant may automatically send a calendar invitation to the participants of the meeting after finding a suitable time for the meeting, thus reducing the burden on the human in scheduling the meeting and notifying the participants of the schedule.

The system may include one or more processors and a memory configured to implement the steps described herein. Processor may be communicatively connected to databases in which it may store and retrieve information. Processor may receive user input to schedule a meeting from, for example, a user interface connected to the processor. User input may identify the participants in the meeting, the length of time of the meeting, and the deadline for the meeting to occur. User input may include additional information such as the topic of the meeting. In some embodiments, user input may identify which participants are required, i.e, which attendants must attend the meeting, and which participants are optional, i.e, which attendants are not required to attend the meeting. In some embodiments, processor sends a preliminary meeting invitation to participants and receives the participants' intention to accept or decline the invitation to attend the meeting, from which processor will update the list of participants.

Processor then extracts calendar information of participants identified in user input. Calendar information may be extracted from third-party calendaring software such as Google® Calendar or Microsoft® Outlook. Processor limits the information extracted to only necessary information for scheduling the meeting, such as participants' calendar/schedule from the present time to the meeting deadline. Processor analyzes the calendaring information of participants and determines one or more timeslots before the deadline that will fit the length of time of the meeting and during which all participants are available. If there are multiple viable timeslots, processor may send the timeslots to user for selection. If no such time exists, processor will determine one or more low cost options.

Processor may determine the cost of scheduling the meeting at a specific time and select one or more proposed times based on the cost. Processor may determine the cost based on one or more factors, such as the number/percentage of participants with scheduling conflicts and/or the level of importance of existing events of participants that conflict with the time. Cost may also depend on the position of a participant with a scheduling conflict. For example, a higher cost may be attributed to a participant with a scheduling conflict if the participant is an executive of an organization than if the participant is an assistant. Processor may determine positions of participants from signature blocks and/or contact information such as electronic business cards. Processor may also receive user input identifying whether participants are required to attend, which may affect the cost if the participant has a scheduling conflict. Calendaring information extracted by processor may identify a level of importance for existing events. Processor may attribute a high cost for scheduling a meeting that overlaps the scheduled time of an event of a participant with a high-level importance, while attributing a low cost for scheduling a meeting that interferes with an event with a low-level importance. Processor may consider the number of participants involved in an already scheduled event as a cost of rescheduling that event to accommodate the current request. Processor may consider some events as immovable or high-cost (such as the time a Professor teaches his/her class) and some events as low-cost (such as a regularly scheduled seminar). In some embodiments, users may designate already scheduled events as high-importance or low-importance (and hence high-cost or low-cost for rescheduling). Processor may apply a color-coding scheme to designate the importance/cost of already scheduled events for processor consideration. Processor may assign a weight and/or number representing the cost to each factor and/or overall cost score for a given time based on the degree of severity or impact that scheduling the meeting at that time would result in. For example, a time when the CEO is unavailable may have a higher weight/score than a time when an assistant is unavailable.

Processor may send user with multiple proposed times for the event based on their respective costs determined, specifically the proposed times with low cost for schedule the event then. Processor receives the selected time from the user and sends the event information with the selected time to the participants. In some embodiments, participants may then confirm whether they will attend the meeting. Once the meeting is scheduled, processor may discard the calendaring information extracted.

Processor may offer several alternatives as possible timeslots for the meeting being scheduled. These alternatives could be based on a “low cost” metric. These alternatives could assist a human to narrow down the options for the meeting time. These options may involve additional rescheduling events when a no-conflict option does not exist to schedule the requested event. The processor may provide options such that the problem of scheduling the current event will result, when unavoidable, in a problem of rescheduling an already scheduled event, but of lower cost/importance. In this process, the processor may guarantee the solution will converge.

In some embodiments, processor may use machine learning techniques to improve the determination of low cost and/or user preferences for scheduling. Processor may use the proposed times, the selected time, and/or corresponding factors such as respective determined costs as training data to fine-tune proposed times by the processor for future scheduling.

In some embodiments, the meeting location may be taken into account in finding a suitable time slot, taking traveling times between meeting locations. In some embodiments, the meetings may take place virtually, over zoom or Webex or other video conferencing software. In such cases, an automatic video conferencing link may be generated as part of the event scheduling.

The processor immediately deletes the collected calendar information after finding a suitable meeting time, thus preserving privacy. The proposed assistant may not divulge the reasons why a requested participant may be busy to the person scheduling the event, when that person is not privy to the information. The proposed assistant can be configured such that a meeting participant may have to give it permission to look into their calendar to preserve privacy and to avoid leaking of information from random meeting requests.

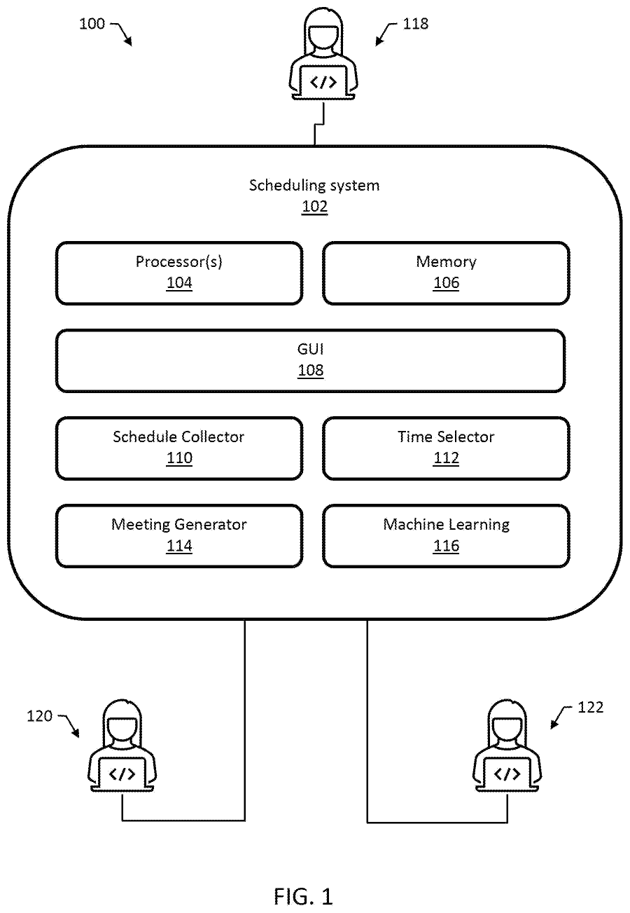

FIG. 1 is a block diagram of an example network environment 100 for a scheduling system 102. The scheduling system 102 is a computer system, for example, one or more servers, and the scheduling system 102 comprises one or more processors 104 and memory 106 storing instructions for the processors 104. The scheduling system 102 is configured for scheduling meetings on computer systems.

The scheduling system 102 includes various components that can be implemented, for example, as software executing on the processors 104. The scheduling system 102 includes a graphical user interface (GUI) 108, a schedule collector 110, a time selector 112, a meeting generator 114, and a machine learning module 116. The scheduling system 102 can communicate with user devices over a data communications network such as the Internet.

In operation, a first user 118 initiates the process of scheduling a meeting by providing meeting information using the GUI 108. The first user 118 invites one or more other users 120 and 122 by specifying contact information for the other users 120 and 122. The scheduling system 102 determines an appropriate time for the meeting based on calendar data from the users 119, 120, and 122 and schedules the meeting on the electronic calendars of the users.

The GUI 108 can include any appropriate information for scheduling a meeting. For example, the GUI can include a calendar view that displays a schedule for the first user 118. The calendar should be easy to navigate, allowing users to quickly switch between days, weeks, or months. It should also be customizable, so users can choose to view their schedule by day, week, or month, and they should be able to filter their schedule by meeting type, attendee, or location.

The GUI 108 can include a meeting creation form. When a user wants to create a new meeting, they can click a “Create Meeting” button to open a meeting creation form. The form should include fields for the meeting title, date, time, location, attendees, and agenda. Users should be able to easily add or remove attendees.

The GUI 108 can include an attendees list that displays all of the user's contacts. Users should be able to filter the attendees list by name, email address, or company. They should also be able to add new attendees to their contact list from the attendees list.

The GUI 108 can include a settings page where users can manage their account settings. The settings page should allow users to change their password, update their contact information, and set their preferences for notifications. In addition to these components, the GUI 108 may also include other features, such as a search bar, a chat window, and a help section.

The schedule collector 110 is configured to collect schedule information from the users 118, 120, and 122. For example, the schedule collector 110 can connect directly to the attendees' calendars using their calendar APIs or web interfaces. This method provides real-time access to calendar information, allowing the collector to gather up-to-date availability data. Alternatively, the attendees can export their calendar data in a standard format, such as .ics or .csv, and import it into the schedule collector 110. This method is less dynamic than direct connection but still allows for accurate availability information. The schedule collector 110 can, in some cases, use self-reported availability information provided by the attendees through surveys, forms, or email responses. This method is simpler to implement but may be less accurate due to human error or incomplete information.

The time selector 112 is configured to select a time for the meeting based on the collected schedule information. The time selector 112 analyzes the schedule data, identifying potential conflicts and constraints that may hinder finding a suitable meeting time. This includes considering factors such as attendees' availability, meeting duration, and preferred meeting times. In some cases, the time selector 112 employs optimization algorithms to evaluate different time slots based on the collected schedule information. These algorithms consider various factors, such as minimizing conflicts, maximizing attendee availability, and adhering to scheduling preferences.

In some examples, the time selector 112 ranks the identified time slots based on their suitability, considering the optimization results and any additional preferences specified by the meeting organizer. The time selector 112 selects the highest-ranked time slot from the list of available options, presenting it to the meeting organizer as the recommended meeting time. In some examples, the time selector 112 includes a feedback mechanism to provide feedback to the meeting organizer about the availability of attendees for the recommended time slot, allowing them to make an informed decision.

The meeting generator 114 is configured for creating and sending meeting invitations to attendees once a suitable time has been selected. Since the attendees may use different calendaring programs or systems, the meeting generator 114 operates by integrating with various calendar programs to seamlessly scheduling meetings across different platforms. In some examples, the meeting generator 114 utilizes calendar APIs or web interfaces to connect with the attendees' calendars, ensuring compatibility with various calendar programs such as Outlook, Google Calendar, and others.

The meeting generator 114 creates a meeting entry in the attendees' calendars, including all the relevant meeting details such as title, date, time, location, agenda, and attendees. The meeting generator 114 can generate and send meeting invitations via email or other communication channels, informing attendees about the scheduled meeting and providing them with a link to add the meeting to their calendars.

The machine learning module 116 is configured for leveraging historical data and predictive algorithms to optimize time selection for meeting organizers. It operates by analyzing patterns in past meeting schedules and utilizing this information to make informed suggestions for future meetings.

In operation, the machine learning module 116 collects historical data on past meetings, including the proposed meeting times, attendee availability, and final selected meeting times. It extracts relevant features from the collected data, such as the average meeting duration, preferred meeting times for each attendee, and patterns in scheduling conflicts. The machine learning module 116 trains a predictive model using the extracted features and the final selected meeting times. The model learns to identify patterns and relationships between the features and the successful scheduling of meetings.

When a meeting organizer schedules a new meeting, the machine learning module utilizes the trained model to predict the meeting time that has the highest probability of accommodating all attendees. The module 116 provides the meeting organizer with a recommendation for the predicted best meeting time, along with relevant insights and supporting data from the historical data.

In some examples, the machine learning module 116 continuously updates its predictive model by incorporating data from newly scheduled meetings, ensuring that the recommendations remain accurate and reflect the evolving scheduling patterns. The module 116 evaluates the performance of its predictions by comparing them to the actual meeting times chosen by meeting organizers. This feedback loop helps to refine the model and improve its predictive accuracy over time. The machine learning module 116 can incorporate real-time data, such as changes in attendee availability or scheduling preferences, to dynamically adjust its predictions and provide the most up-to-date recommendations. The machine learning module 116 can incorporate on how conflicts are being resolved by the humans and how a choice is being made among the available low-cost options provided to the humans. The machine learning module 116 can incorporate how additional rescheduling events are handled by humans in order to schedule the currently requested meeting.

The scheduling system 102 is configured to discard user scheduling information after a meeting has been scheduled. This helps to ensure user privacy. The system 102 can also use any other appropriate techniques for ensuring data privacy for users.

For example, the system 102 can be configured to only collect and store the minimum amount of data necessary for its intended purpose, which is to schedule meetings. This means avoiding collecting unnecessary personal information, such as full names, addresses, or phone numbers.

When storing scheduling information, the system 102 can anonymize it by removing personally identifiable information. This can be done by assigning unique identifiers to attendees instead of using their names or email addresses.

The system 102 can encrypt all scheduling data, both at rest and in transit. This will help to protect the data from unauthorized access, even if the attacker is able to gain access to the program's servers or databases.

The system 102 can implement strict access controls to ensure that only authorized users can access scheduling information. This can be done by using role-based access control (RBAC) or other access control mechanisms. The system 102 can obtain explicit consent from users before collecting or using any of their personal information. This consent should be clear and easy to understand, and it should explain how the data will be used and stored.

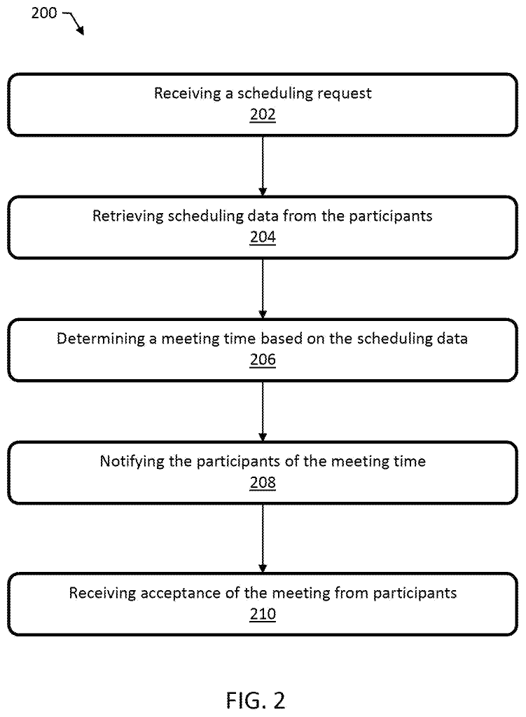

FIG. 2 is a flow diagram of an example method 200 for scheduling a meeting. The method 200 can be performed by a computer system comprising one or more processors and memory storing instructions for the processors.

The method 200 includes receiving 202 a scheduling request from an organizer for a meeting, the scheduling request identifying a deadline or a window for the meeting, a length of time of the meeting, and participants of the meeting. The scheduling request can be received, for example, through a web interface. A web-based interface provides a user-friendly platform where organizers can log in and input the scheduling details. The organizer fills out a form or uses a graphical calendar interface to specify the meeting parameters and participants. Alternatively, the scheduling request can be received through calendar integration (e.g., Microsoft Outlook, Google Calendar), through an API, or from a chatbot or virtual assistant.

The method 200 includes retrieving 204 scheduling data from each of the participants, the scheduling data comprising availability of the participants. Retrieving scheduling data from participants involves accessing and aggregating information about their availability and existing commitments. The scheduling program typically interfaces with participants' calendar systems or scheduling tools to gather this data.

Integration with popular calendar applications such as Google Calendar, Microsoft Outlook, or other collaboration platforms allows the program to extract details about participants' existing appointments, meetings, or marked availability. The program may use secure APIs to connect with these external systems, ensuring real-time and accurate retrieval of scheduling data. Additionally, participants might have provided their scheduling preferences directly to the scheduling program, specifying their regular working hours, preferred meeting times, or blackout periods. The program may consider the user work locations in organizing a physical or virtual meeting. These preferences can be factored into the scheduling algorithm to propose meeting times that align with participants' individual preferences.

The method 200 includes determining 206 a meeting time based on the scheduling data. Determining the meeting time can include executing algorithm that considers the collected scheduling data to identify a suitable time slot that accommodates the availability of all participants.

The algorithm is configured to navigate through the constraints provided by the meeting deadline or window, the desired meeting duration, and the individual availability patterns of participants. For example, determining the meeting time can include employing optimization algorithms that weigh factors such as minimizing conflicts, equalizing the distribution of meeting times among participants, and prioritizing the organizer's preferences. The algorithm may iteratively propose potential meeting times, evaluate their feasibility based on participants' schedules, and adjust until a mutually agreeable time is found.

Machine learning techniques can enhance the algorithm's predictive capabilities, learning from historical data to anticipate participants' availability patterns and preferences. A model can be trained to strike a balance that satisfies the organizer's objectives while respecting the constraints and preferences of each participant, resulting in an optimized and acceptable meeting time for all involved parties.

The method 200 includes notifying 208 the participants of the meeting time. Notifications can be sent through various channels such as email, calendar invitations, or dedicated notification systems. The notification includes details like the finalized meeting time, duration, and any additional relevant information.

The method 200 includes receiving 210 acceptance of the meeting from the participants. Participants, upon receiving the notification, are prompted to respond with their acceptance or rejection of the proposed meeting time. The scheduling program can be configured to monitor and record the responses from each participant. In case of rejections or conflicts, the program may need to revisit the scheduling algorithm and propose alternative meeting times until a consensus is reached. The scheduling program can be configured to schedule a meeting as long as a quorum of required participants is reached.

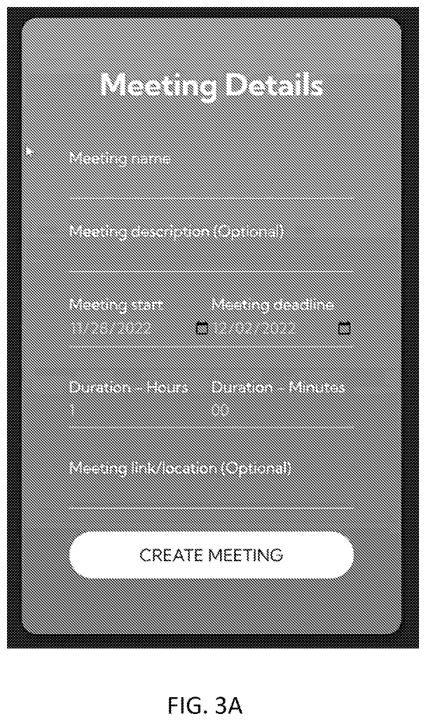

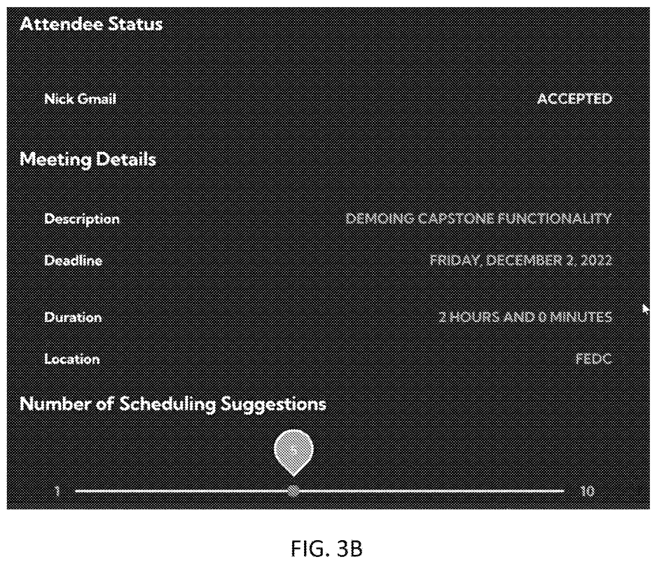

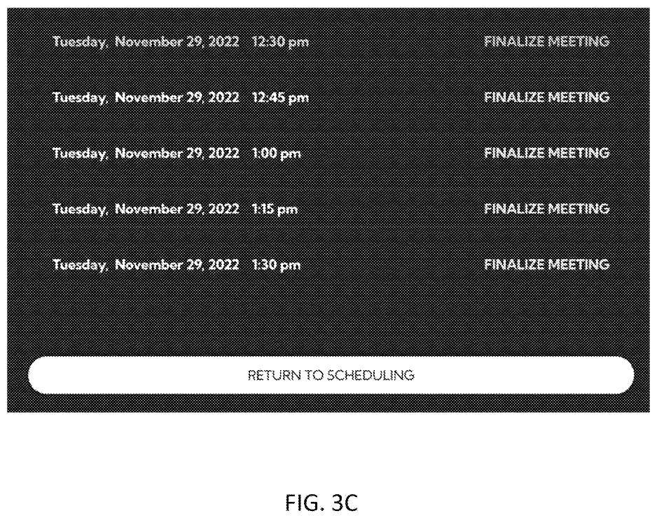

FIGS. 3A-3C are screen shots from an example GUI for a scheduler in a web-based interface. FIG. 3A shows a screen for receiving meeting invitation details. FIG. 3B shows a screen for viewing an attendee list, meeting details, and a number of scheduling suggestions user interface element which can be used to specify a number of desired time suggestions. This screen can also include a user interface element such as a button to generate suggestions. FIG. 3C shows a screen displaying suggested times for the meeting and user interface elements to finalize one of the times for the meeting.

After receiving responses from all participants, the scheduling program finalizes the meeting schedule. If there are conflicting responses, it may go through an iterative process to find a consensus. The final schedule is communicated to all participants, and any necessary updates are made to their calendars.

It will be understood that various details of the presently disclosed subject matter can be changed without departing from the scope of the presently disclosed subject matter. Furthermore, the foregoing description is for the purpose of illustration only, and not for the purpose of limitation.

The control systems and computer systems described herein may be implemented in hardware, software, firmware, or any combination thereof. In some exemplary implementations, the subject matter described herein may be implemented using a computer readable medium having stored thereon computer executable instructions that when executed by the processor of a computer control the computer to perform steps.

Exemplary computer readable media suitable for implementing the subject matter described herein include non-transitory computer readable media, such as disk memory devices, chip memory devices, programmable logic devices, and application specific integrated circuits. In addition, a computer readable medium that implements the subject matter described herein may be located on a single device or computing platform or may be distributed across multiple devices or computing platforms.

What is claimed is:

1. A method comprising:
receiving a scheduling request from an organizer for a meeting, the scheduling request identifying a deadline or a window for the meeting, a length of time of the meeting, and participants of the meeting;
retrieving scheduling data from each of the participants, the scheduling data comprising availability of the participants;
determining a meeting time based on the scheduling data;
notifying the participants of the meeting time; and
receiving acceptance of the meeting from the participants.

2. The method of claim 1 further comprising:
determining from the scheduling data that there is no qualifying time in which all of the participants are available;
determining a cost for each time of a plurality of times based on availability of the participants for each respective time;
selecting one or more proposed times of the plurality of times with low costs; and
receiving a meeting time selected among the one or more proposed times.

3. The method of claim 2 wherein the cost is based on a position of the participants.

4. The method of claim 2 wherein the cost is based on an amount of unavailable participants.

5. The method of claim 2 wherein the cost is based on a difficulty of rescheduling conflicting meetings.

6. The method of claim 2 wherein selecting one or more proposed times includes implementing one or more machine learning techniques using prior iterations of proposed times and corresponding selected meeting times.

7. The method of claim 2 comprising learning, by a machine learning component, from one or more choices and decisions being made by the participants.

8. The method of claim 2 further comprising discarding the scheduling data after the meeting time is determined.

9. The method of claim 2 comprising sending out a calendar invitation with appropriate information for the meeting.

10. The method of claim 9 wherein the calendar invitation further incorporates a virtual meeting invitation.

11. A system comprising:
one or more processors and memory storing executable instructions for the one or more processors; and
a scheduler implemented on the one or more processors and configured for:
receiving a scheduling request from an organizer for a meeting, the scheduling request identifying a deadline or a window for the meeting, a length of time of the meeting, and participants of the meeting;
retrieving scheduling data from each of the participants, the scheduling data comprising availability of the participants;
determining a meeting time based on the scheduling data;
notifying the participants of the meeting time; and
receiving acceptance of the meeting from the participants.

12. The system of claim 11, wherein the scheduler is configured for:
determining from the scheduling data that there is no qualifying time in which all of the participants are available;
determining a cost for each time of a plurality of times based on availability of the participants for each respective time;
selecting one or more proposed times of the plurality of times with low costs; and
receiving a meeting time selected among the one or more proposed times.

13. The system of claim 12, wherein the cost is based on a position of the participants.

14. The system of claim 12, wherein the cost is based on an amount of unavailable participants.

15. The system of claim 12, wherein the cost is based on a difficulty of rescheduling conflicting meetings.

16. The system of claim 12, wherein selecting one or more proposed times includes implementing one or more machine learning techniques using prior iterations of proposed times and corresponding selected meeting times.

17. The system of claim 12, comprising a machine learning component configured for learning from one or more choices and decisions being made by the participants.

18. The system of claim 12, wherein the scheduler is configured for discarding the scheduling data after the meeting time is determined.

19. The system of claim 12, wherein the scheduler is configured for sending out a calendar invitation with appropriate information for the meeting.

20. The system of claim 19, wherein the calendar invitation further incorporates a virtual meeting invitation.

21. A non-transitory computer readable medium storing executable instructions that, when executed by at least one processor of a computer system, cause the computer system to perform operations comprising:
receiving a scheduling request from an organizer for a meeting, the scheduling request identifying a deadline or a window for the meeting, a length of time of the meeting, and participants of the meeting;
retrieving scheduling data from each of the participants, the scheduling data comprising availability of the participants;
determining a meeting time based on the scheduling data;
notifying the participants of the meeting time; and
receiving acceptance of the meeting from the participants.
